(19) United States
(12) Patent Application Publication
(10) Pub. No.: US 2021/0086393 A1
(43) Pub. Date: Mar. 25, 2021

(54) SAWMILL SYSTEM WITH BIDIRECTIONAL BANDSAW CAPABILITY USING OPPOSITELY DIRECTED SINGLE-SIDED BLADES

(71) Applicant: GEORGE WILLOUGHBY JOHNSON, KANSAS CITY, MO (US)

(72) Inventor: GEORGE WILLOUGHBY JOHNSON, KANSAS CITY, MO (US)

(21) Appl. No.: 16/580,077

(22) Filed: Sep. 24, 2019

(51) Int. Cl. B27B 15/02; B27B 33/06; B27B 1/00; B27B 15/08

(52) U.S. Cl. CPC B27B 15/02; B27B 15/08; B27B 1/00; B27B 33/06

(57) ABSTRACT

A sawmill for cutting logs in successive bi-directional passes that includes a pair of horizontally extending beams, a carriage assembly and a saw head mounted atop the carriage assembly. The saw head includes a band saw drive source and at least one set of first and second band saw blade wheels. First and second band saw blades partially circumscribe the first and second band saw blade wheels with the cutting edge of the first and second band saw blades directed oppositely from one another so that as the carriage assembly and saw head travel along the frame the log is cut by the first saw blade and as the carriage assembly and saw head reciprocates on the beams in the opposite direction, a second section is cut from the log by the second band saw blade.

### TECHNICAL FIELD

The sawmill disclosed herein is directed to a mill with bidirectional bandsaw cutting capability provided by two directionally opposed cutting blades mounted on a traveling carriage for cutting horizontal sections from logs in successive back and forth passes.

### BACKGROUND

The conversion of harvested logs into a finished lumber product comprises many steps from forest to sawmill and from sawmill to lumberyard. Because of increased competition, both foreign and domestic, the modern lumber industry has had to face a new range of problems to survive and prosper. Because of the increased cost of logs, their limited availability and generally smaller sizes, it is essential to obtain as much lumber value from each log as possible. Increasing equipment and labor costs have also made it necessary to obtain that lumber efficiently and economically. In addition, it has become important to limit waste, both to increase yield and for environmental reasons. These factors then make it essential to modernize the lumber-producing art.

In view of the above, it is advantageous to minimize the amount of time and energy required to produce a set number of board feet of lumber per unit of time. The current state of the art includes portable mills that are exceptionally capable of unidirectional sawing of logs. The time required to re-position the bandsaw to the opposing longitudinal end of the carriage is a needless drain on the time available to complete the production of a set number of board feet.

The sawmills disclosed herein utilize a bandsaw that is a long, sharp blade consisting of a continuous band of toothed metal stretched between two or more wheels to cut material. Bandsaw blades that are utilized in portable sawmill operations most commonly have a toothed edge and a flat blade back. The flat blade back portion of the blade has a thickness, generally referred to as the “gauge.” The toothed edge many times will have a tooth pattern that includes a side clearance angle that causes the toothed edge to have a “set” that is wider than the gauge. The set of the blade creates the “kerf,” the slit or notch made as the saw blade advances through the work piece to be wider than the gauge of the blade. When the sawmill is operating the flat blade back rides on the flat outer circumference surface of the blade wheel while the toothed edge overhangs the rotating blade wheel. The toothed edge must overhang, or extend beyond, the outer edge of the blade wheel to prevent loading of one side of the toothed edge and possibly adversely altering the set of the blade.

Also, when sharpening bandsaw blades that have become dull from extensive use or possibly from striking a metal object, such as a nail or a staple embedded in the work piece, it is important during the sharpening process for the flat blade back to provide a level surface so that the grinding of the tooth face is performed at the correct angle relative to the flat blade back.

The flat blade back of the single cutting-edge bandsaw is central to the functionality of the bandsaw saw mill. The “set” on the blade which results in a tooth area thickness greater than the “gauge” of the flat blade back restricts, and operationally prohibits, the riding of the bandsaw teeth on the outer circumference of the blade wheels and the guide rollers. The utilization of bandsaw blades with double toothed edges may appear to be an obvious solution to the challenge of increasing operational efficiency; however, double tooth edged bandsaw blades are far more expensive than single cutting edge and the ability to sharpen double-sided blades is also far more complicated and very costly. The operational and economic deficiencies associated with double cutting-edge bandsaw blades necessitates a much closer look at how to optimize the use of two single relatively inexpensive cutting-edge bandsaw blades to provide for cutting of the log in both directions.

While bidirectional band saw mills do exist in the marketplace, they are heavy industrial-scale machines and utilize very expensive and difficult-to-maintain two-sided blades. By using two, inexpensive, single-sided blades oppositely directed and closely spaced, the apparatus as disclosed herein eliminates the need for an expensive two-sided blade. This offers the benefits of bi-directional sawing to a light-industrial and hobby level of sawmill owner which heretofore have been financially out of reach.

### SUMMARY

Disclosed herein is a portable sawmill that utilizes two band saws mounted back to back on a carriage with a saw head for cutting through logs with successive back and forth passes as the carriage and saw head reciprocate on a frame. A section of the log is cut with one band saw in one pass and then a next section of the log is cut by the other oppositely directed band saw blade as the carriage and saw head travel in the opposite direction during the following pass.

The sawmill with bidirectional bandsaws also includes a mechanism that facilitates the simultaneous raising and lowering of both band saws for cutting sections from the log so that each respective band saw can be positioned for making the appropriate depth of cut through the section of the log during that respective pass of the respective band saw.

The disclosed sawmill may be configured in at least two separate embodiments. The first embodiment relies upon two laterally disposed across the frame blade wheels which restrain and provide rotational power to the two oppositely directed bandsaw blade wheels. The two blade wheels are disposed on opposite sides of the sawmill and along with either two or four spaced apart guide rollers, serve to guide and level the bandsaw blades and create the cutting throat through which the log passes during the sawing operation. The two blade wheels may optionally utilize a rib adjacent the trailing edge of the bandsaw blade to minimize, or preferably eliminate, the potential for the bandsaw blade to slide off the blade during sawing operations due to the high shearing forces experienced by the bandsaw blade during the sawing of the log.

An alternative second embodiment utilizes a total of four blade wheels, two per laterally opposite sides of the mill. With this second embodiment, a separate bandsaw blade is wrapped around each pair of oppositely disposed blade wheels. The bandsaw blades as in the first embodiment utilize a cutting edge and a trailing edge. The trailing edge of the bandsaw blade in this second embodiment may also butt up against a circumferential rib on the blade wheels that restrains the bandsaw blade against movement off the blade wheels. The two sets of blade wheels and bandsaw blades are preferably closely spaced from one another to avoid the potential for the trailing edge of the second blade binding against a surface of the log as the cutting-edge passes through the log.

This configuration of a sawmill with the bidirectional bandsaw capability is unique in that it saves the time required to recycle the saw head to the starting position and therefore this design can produce more board feet per unit of time than a sawmill without a dual bandsaw configuration.

It is an object of the disclosed saw mill with bidirectional bandsaw to substantially increase the throughput in board feet of lumber cut per unit of time by eliminating unnecessary carriage recycle time.

It is an object of the disclosed saw mill with bidirectional bandsaw to maintain a high mechanical efficiency by utilizing an bidirectional sawing system that does not rely upon a complicated mechanism for sawing or changing elevation of the saw head.

It is an object of the disclosed saw mill with bidirectional bandsaw to minimize mechanical maintenance requirements.

It is an object of the disclosed saw mill with bidirectional bandsaw to minimize operational and maintenance safety concerns.

Various objects, features, aspects and advantages of the disclosed subject matter will become more apparent from the following detailed description of preferred embodiments, along with the accompanying drawings in which like numerals represent like components. The contents of this summary section are provided only as a simplified introduction to the disclosure, and are not intended to be used to limit the scope of the appended claims.

### BRIEF DESCRIPTION OF THE DRAWINGS

FIG. 1 illustrates a perspective view of a fully assembled embodiment of a saw mill with bidirectional bandsaw as disclosed herein;

FIG. 2 illustrates an exploded right-side view of an embodiment of the saw mill with bidirectional bandsaw as disclosed herein;

FIG. 3 illustrates an exploded left-side view of an embodiment of the saw mill with bidirectional bandsaw as disclosed herein;

FIG. 4 illustrates a perspective view of an embodiment of the frame of the saw mill with bidirectional bandsaw as disclosed herein;

FIG. 5 illustrates a perspective view of an embodiment of the carriage of the saw mill with bidirectional bandsaw as disclosed herein;

FIG. 6 illustrates a perspective view of an embodiment of the saw head of the saw mill with bidirectional bandsaw as disclosed herein;

FIG. 7A illustrates a front elevation view of an embodiment of the blade wheel configuration as disclosed in FIG. 6;

FIG. 7B illustrates a side elevation view of an embodiment of the blade wheel configuration of the saw mill with bidirectional bandsaw as disclosed from view 7B-7B in FIG. 7A;

FIG. 8 illustrates a perspective view of an embodiment of the two-guide roller and bandsaw configuration as disclosed herein;

FIG. 9 illustrates a perspective view of an alternative embodiment of the blade wheel configuration of the saw mill with bidirectional bandsaw as disclosed herein;

FIG. 10 illustrates a perspective view of an embodiment of the four-guide roller and bandsaw configuration as disclosed herein;

FIG. 11A illustrates a front elevation view of an embodiment of the two-blade wheel configuration as disclosed herein;

FIG. 11B illustrates a side elevation view of an embodiment of the two-blade wheel configuration of the saw mill with bidirectional bandsaw as disclosed from view 11B-11B in FIG. 11A;

FIG. 12 illustrates a perspective view of the saw mill with bidirectional bandsaw advancing through a log in a first direction D1;

FIG. 13 illustrates a perspective view of the saw mill with bidirectional bandsaw advancing through a log in a second direction D2; and

FIG. 14 illustrates a front elevation view of the cutting throat of the saw mill with bidirectional bandsaw advancing through a log.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

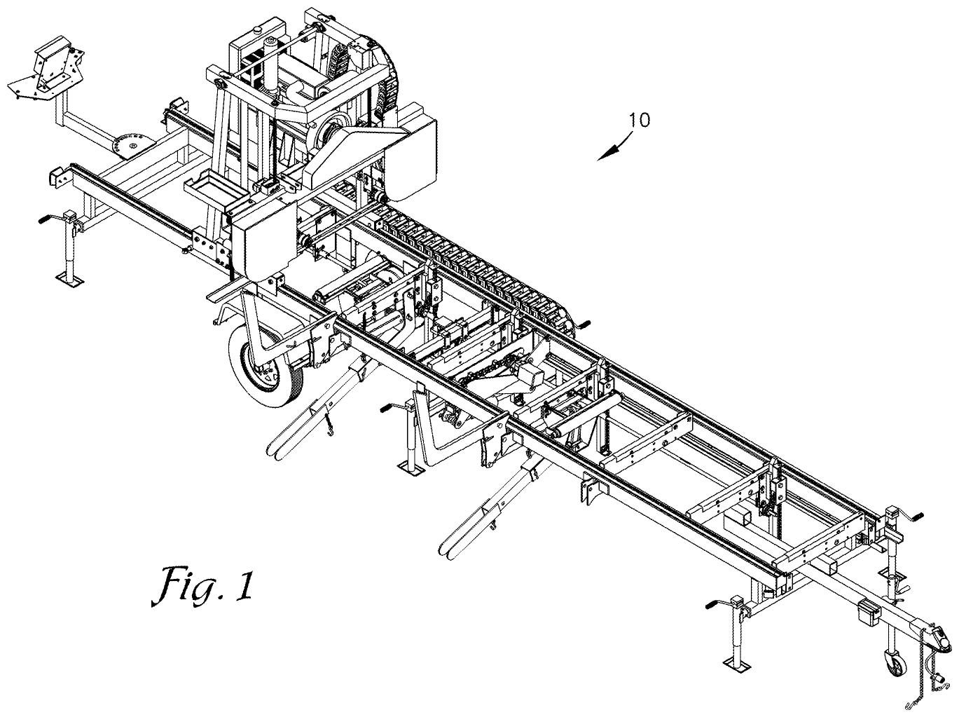

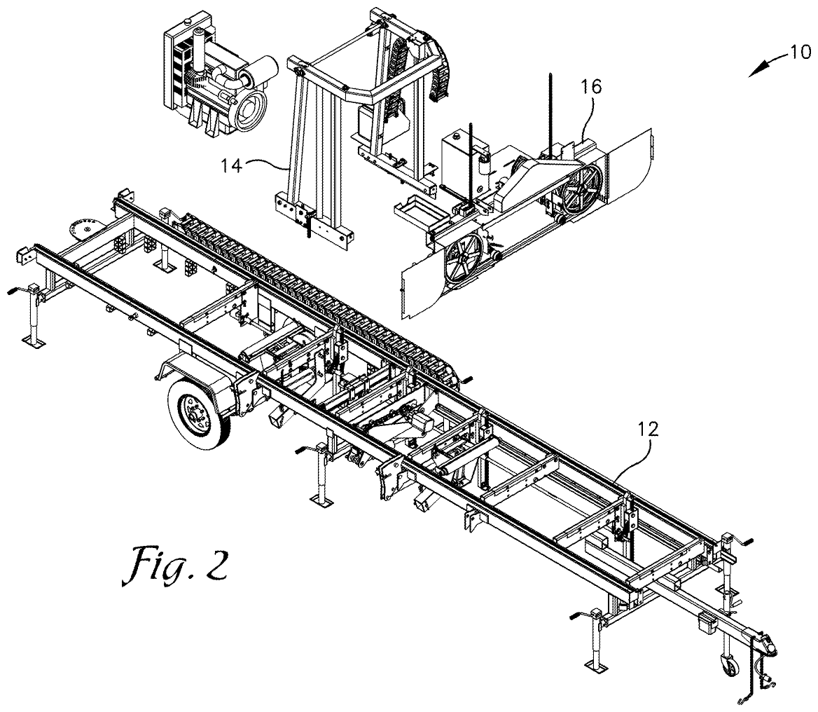

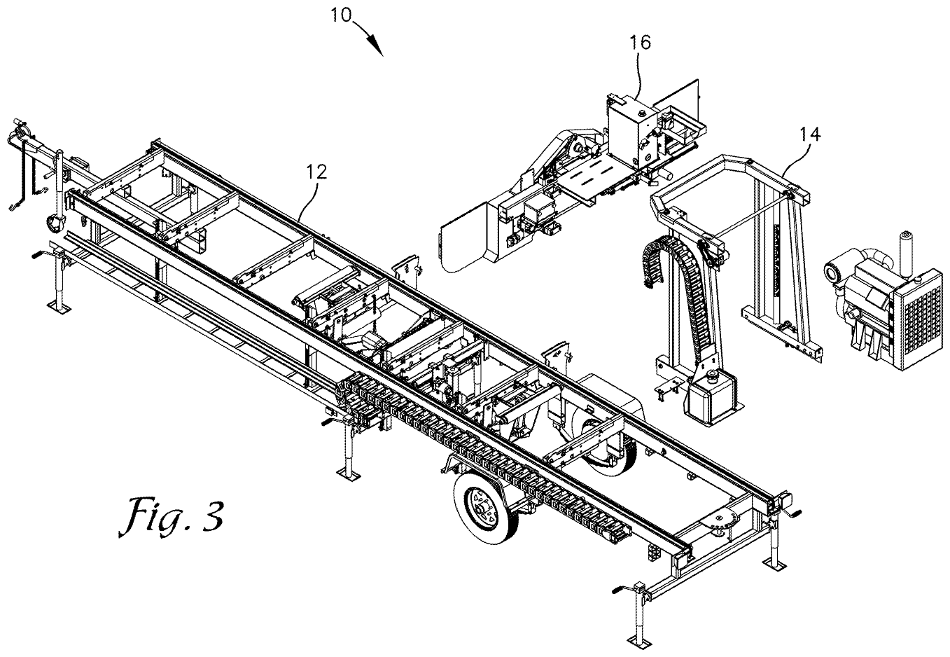

Disclosed herein and as shown at FIG. 1 is a fully assembled view of the saw mill with bidirectional bandsaw 10, while FIGS. 2 and 3 are exploded assembly views of the saw mill 10 from left and right perspectives. The sawmill with bi-directional bandsaw 10 is described below as comprising three separate major component areas to include the deck, also commonly known as the frame 12, the carriage 14 and the saw head 16.

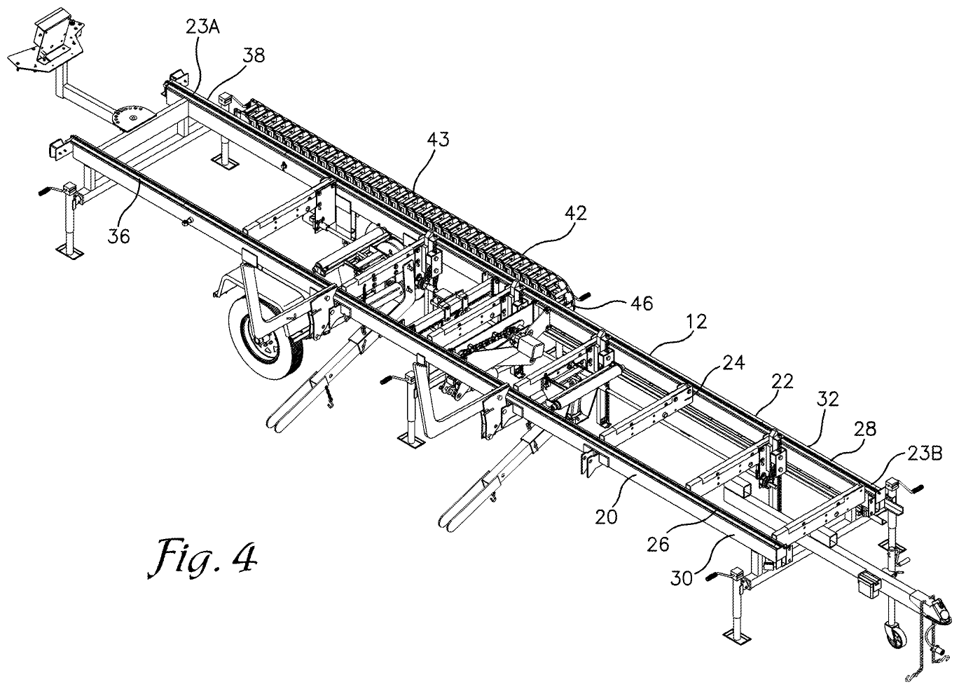

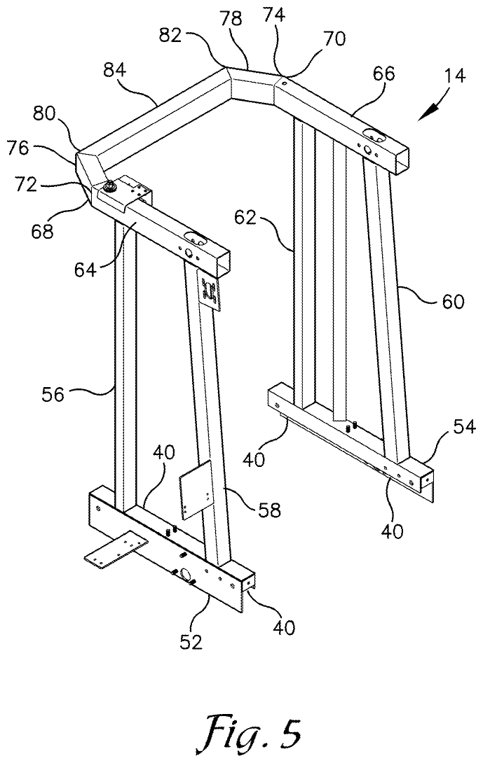

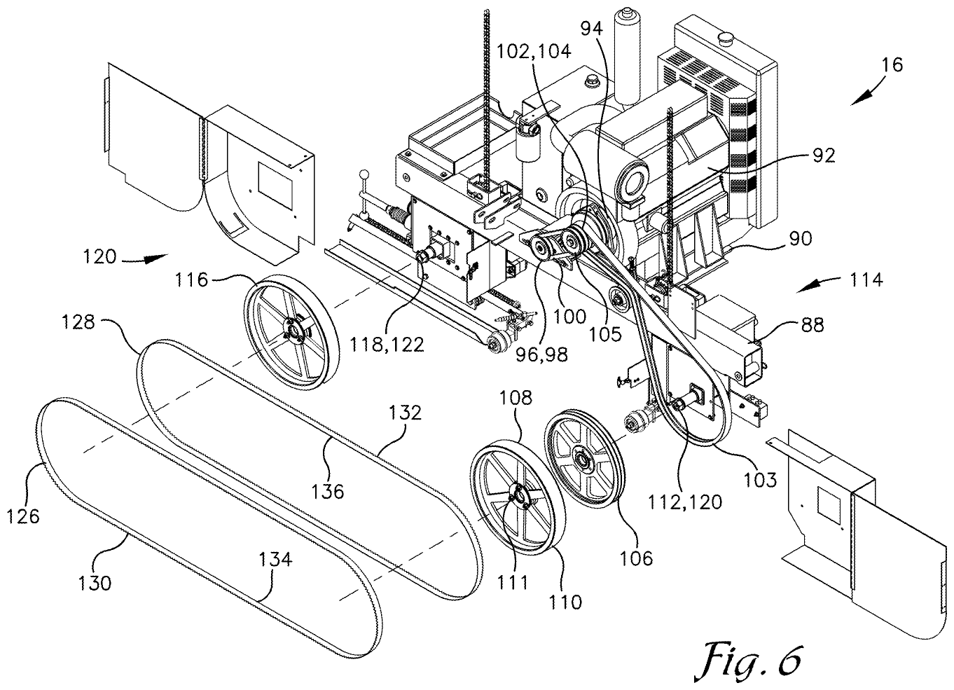

FIG. 4 is a perspective view of the frame 12 comprising first and second spaced apart horizontally and longitudinally extending beams 20, 22 of the sawmill 10 with a proximal end 23A of the frame near the operator's controls and a distal end 23B longitudinally opposite the proximal end 23A. The beams are preferably fabricated from standard steel framing such as box tubing, C-channel members or I-beams that can provide sufficient structural rigidity to handle logs weighing several tons. Cross members 24 are also utilized to tie together the first and second spaced apart beams 20, 22. Drive chains 26, 28 are disposed along the top surfaces 30, 32 of the horizontally extending beams 20, 22 and are part of the drive mechanism 34 that translates the carriage 14 (FIG. 5) and saw head 16 (FIG. 6) along the horizontally extending beams.

FIG. 4 also reveals that secured atop the beams 20, 22 are circular rails 36, 38 that span the entire expanse of the horizontally extending beams. Four rollers 40, the location of which are seen in FIG. 5, support the carriage weldment 14 and reside beneath the carriage 14 and translate upon the circular rails 36, 38. The circular rails 36, 38 provide a surface upon which the rollers 40 can efficiently translate to facilitate movement of the carriage weldment 14 and saw head 16 along the entire expanse of the rails 36, 38 thereby allowing the bandsaw to make horizontal cuts in a log positioned on the frame 12.

An energy chain 42, as seen in FIG. 4, such as manufactured by Igus™, provides a flexible conduit for the placement, and protection, of hydraulic hoses 43 that extend from a starting point proximate the hydraulic pump on the carriage 14 to a fixed point 46 on one of the horizontally extending beams 22. The carriage 14 translates back and forth along the two spaced apart beams 20, 22 with each pass of the band saw.

FIG. 5 reveals that the saw carriage weldment 14 is comprised of two preferably square tubular or alternatively C-channel base members 52, 54 into which two substantially vertical riser support columns 56, 58, 60, 62 extend from each tubular base member. The two vertical support columns on each side of the saw carriage weldment 14 each support an upper saw carriage horizontal member 64, 66. The first end 68, 70 of each upper saw carriage horizontal support member 64, 66 are joined to a first end 72, 74 of a spanner member 76, 78. The second end 80, 82 of each spanner member 76, 78 is connected to an end of a bridge member 84. The bridge member 84 joins the saw carriage weldment 50 into a single structurally rigid member. All saw carriage weldment 14 members are preferably fabricated from steel.

The third major component of the sawmill with a bi-directional bandsaw 10 is the saw head 16. The saw head 16, as seen in FIG. 6, is comprised of the saw head weldment 88 and a support plate 90 which extends horizontally outwardly from the saw head weldment 88. The sawmill 10 engine 92 is preferably mounted to the support plate 90 with an output shaft 94 extending distally from the engine 92. The output shaft 94 is connected to an electromagnetic clutch 102. An exemplary electromagnetic clutch 102 for this disclosed sawmill application is manufactured by Ogura Industrial Corporation; however, reference to this specific clutch should not be considered limiting and many vendors produce electromagnetic clutches that can accommodate the operational demands of the saw mill 10 as described herein.

When the operator of the sawmill desires to cause rotation of the bandsaw blades for log cutting purposes, she engages the electromagnetic clutch 102, with a selectable switch, causing a first clutch pulley 104 to rotate under the power of the engine 92. In a fully assembled and functional configuration, the first clutch pulley 104 is partially surrounded by a saw mill drive belt 103. The same drive belt 103 also partially surrounds a drive wheel 106. The functionality of the drive wheel 106 will be further detailed below in this detailed description section.

A preferred embodiment of the electromagnetic clutch 102 includes a second clutch pulley 105 located distally from the first clutch pulley 104. Whenever the engine 92 is operating, the second clutch pulley 105 is rotating. A second drive belt 100 partially circumscribes the second clutch pulley 105 and partially circumscribes the drive pulley 98 of the hydraulic pump 96. The second clutch pulley 105 provides continuous rotational power to the hydraulic pump 96 so that sawmill's hydraulic accessories may be operated even when rotational power through the first clutch pulley 104 is not needed to drive the bandsaw blades.

The disclosed sawmill with bi-directional bandsaw 10 utilizes at least two distinct embodiments. Both embodiments rely upon the transfer of rotational motion to the drive pulley 106 as detailed above. In the first embodiment, as illustrated in FIG. 6, the drive pulley 106 is concentrically secured to the backside 108 of a first blade wheel 110 by a plurality of fasteners 111 and both wheels are mounted upon a blade wheel shaft 112 on the drive side 114 of the sawmill. With the drive pulley 106 secured with fasteners to the first blade wheel 110 the two wheels rotate at the same number of revolutions per minute. A second blade wheel 116 is disposed laterally across the frame 12 from the first blade wheel 110 and is secured to the saw head 16 with a second blade wheel shaft 118 on the idle, or unpowered side 120.

Both blade wheels 110, 116 rotate about bearings 120, 122 mounted upon the blade wheel shafts 112, 118. The blade wheel shafts 112, 118 and the blade wheels 110, 116 are supported in position by the saw head weldment 88. As noted above, partially surrounding the drive pulley 106 and the first clutch pulley 104 is at least one rubberized blade drive belt 103 that rotates the drive pulley 106 and the first blade wheel 110 that is attached to the drive pulley.

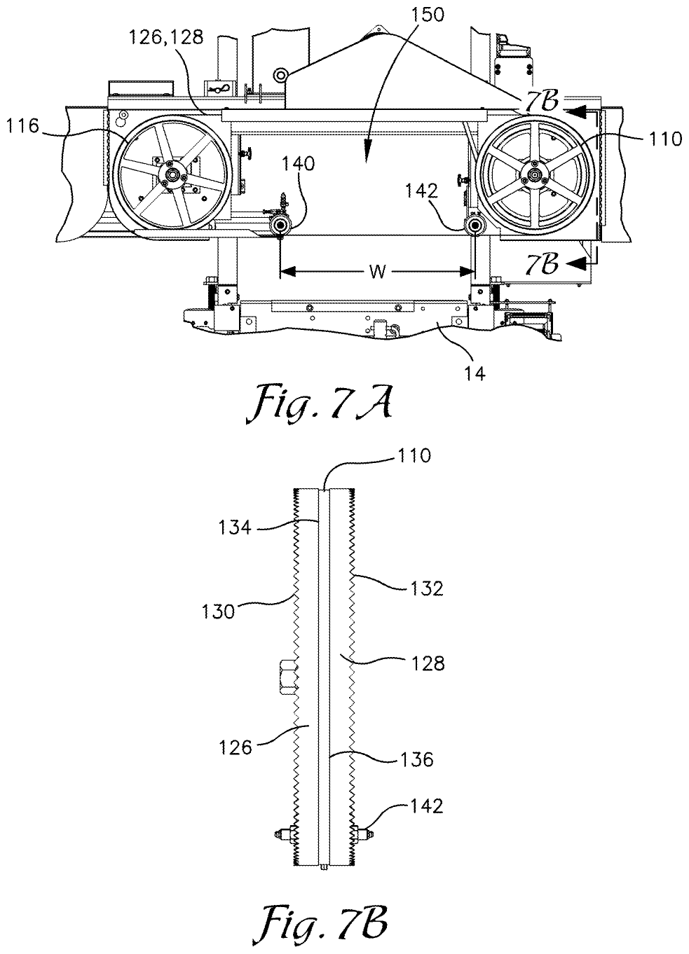

As also seen in FIGS. 6 and 7A, 7B, each of the blade wheels 110, 116 is configured to support two oppositely directed bandsaw blades 126, 128. Each bandsaw blade includes a cutting edge 130, 132 and a trailing edge 134, 136. In this first embodiment, the two oppositely directed bandsaw blades 126, 128 are mounted trailing-edge 134 to trailing-edge 136 on a single blade wheel 110, 116 on each side of the sawmill 10 as best seen in FIGS. 6 and 7A. The blade wheels 110, 116 are configured to facilitate rotation of both bandsaw blades 126, 128 on a single blade wheel, per side, as well as to maintain the rotating bandsaw blades in position on the wheels.

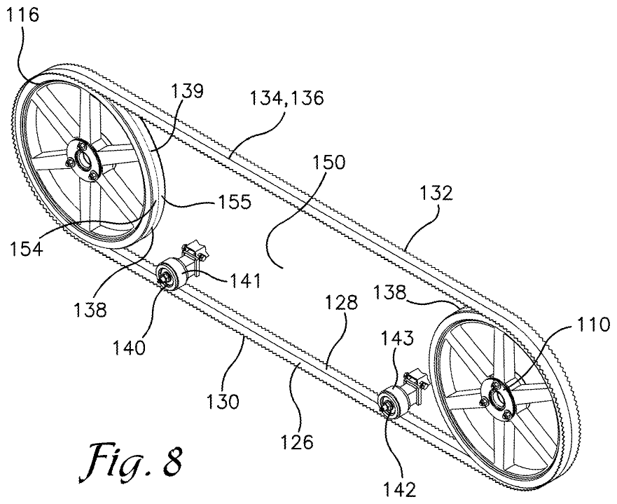

As seen in FIG. 8, an optional configuration for the blade wheels 110, 116 includes a narrow centrally disposed rib 138, 139 separating the two running surfaces 154, 155 of the blade wheels. The ribs 138, 139 serve to prevent one of the oppositely facing blades 126, 128 from shifting into the space occupied by the other blade due to the shearing force applied to the blade during the cutting operation. Specifically, the ribs 138, 139 serve as a backstop to the trailing edge 134, 136 of the bandsaw blades 126, 128 and counteracts the force applied to the blades as the blades advance through the log during the horizontal cuts.

At least two guide rollers 140, 142, as seen in FIG. 8, are utilized to maintain the position of the bandsaw blades 126, 128 during operation and preferably level to the frame 14 to produce finished lumber product that is square/rectangular. The guide rollers 140, 142 are disposed on opposite sides of the frame 12 and serve to define the horizontal outer bounds of the cutting throat 150 of the sawmill 10. The cutting throat 150 width dictates the maximum width of the log that may be cut on the mill 10. Because of the “set” of the teeth of the bandsaw blades, the rolling faces 141, 143 of the guides 140, 142 do not encroach upon the cutting edge 130, 132 of the bandsaw blades 126, 128 leaving the cutting edges untouched by the guide rollers 140, 142.

The width dimension (W) of the cutting throat 150, as seen in FIG. 7A, is determined by the distance between the oppositely disposed guide rollers 140, 142. The W dimension determines the width of log that can pass through the cutting throat 150. The height dimension of logs that the mill is capable of sawing, is determined by the elevation to which the saw head 16 can raise the bandsaw blades 126, 128 above the frame 12. The guide rollers 140, 142 on the first embodiment as detailed above, may be unibody rollers, such as seen in FIG. 8, or alternatively may consist of two separate guide rollers per side of the frame 12. Or more precisely, one guide roller for each bandsaw blade 126, 128 on each side of the sawmill for a total of four guide rollers.

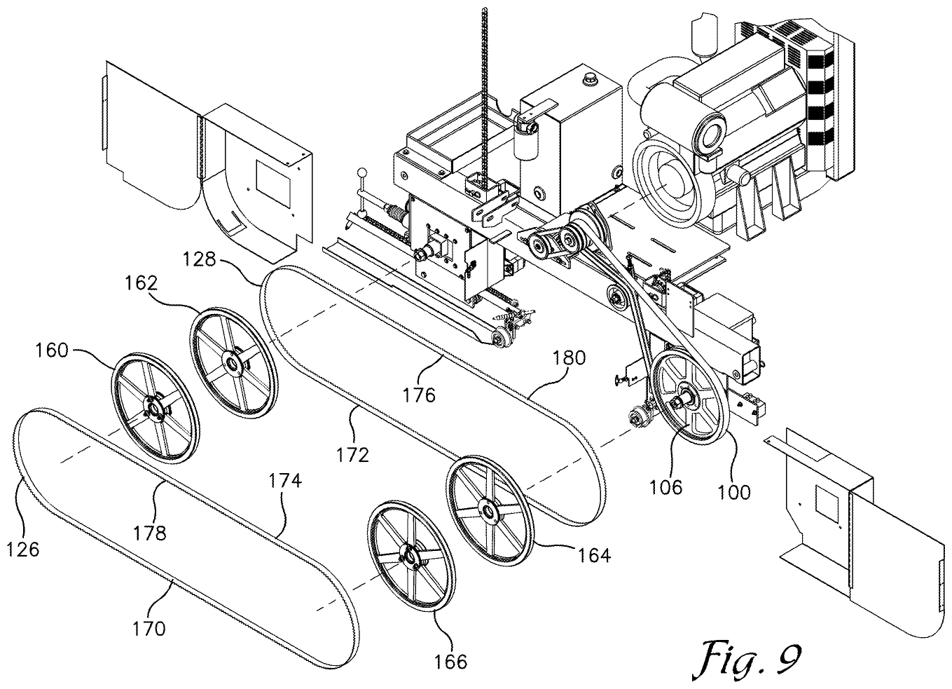

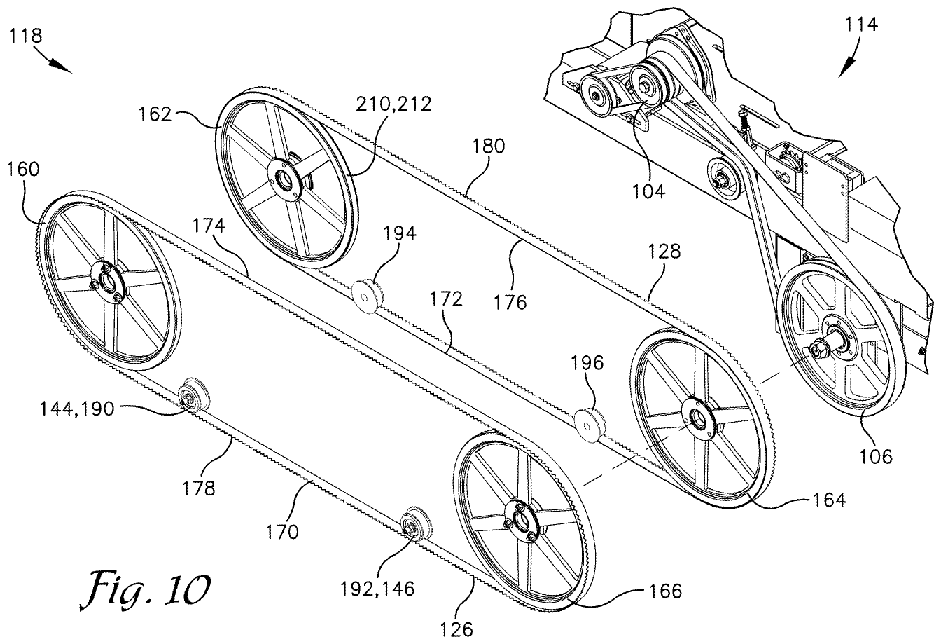

The second embodiment of the sawmill 10 with bidirectional bandsaws 10, as seen in partial assembly and exploded FIGS. 9 and 10, utilizes two blade wheels 160, 162, 164, 166 per lateral side 114, 118 of the frame 12 as opposed to a single blade wheel on each side 114, 118 of the frame as disclosed with the first embodiment. The drive pulley 106 is preferably located behind the most proximally located blade wheel 164 on the drive side 114 of the sawmill 10. Alternatively, but less desirably, the drive pulley 106 may be interposed between the two blade wheels 164, 166 on the drive side 114; however, this configuration requires a spacer (not shown) of thickness equivalent to the drive pulley 106 to be disposed between the blade drive wheels 160, 162 on the unpowered side 118 to prevent kinking of the blades. In this embodiment, each pair of blade wheels [160, 166 and 162, 164] supports and drives their own bandsaw blade 126, 128.

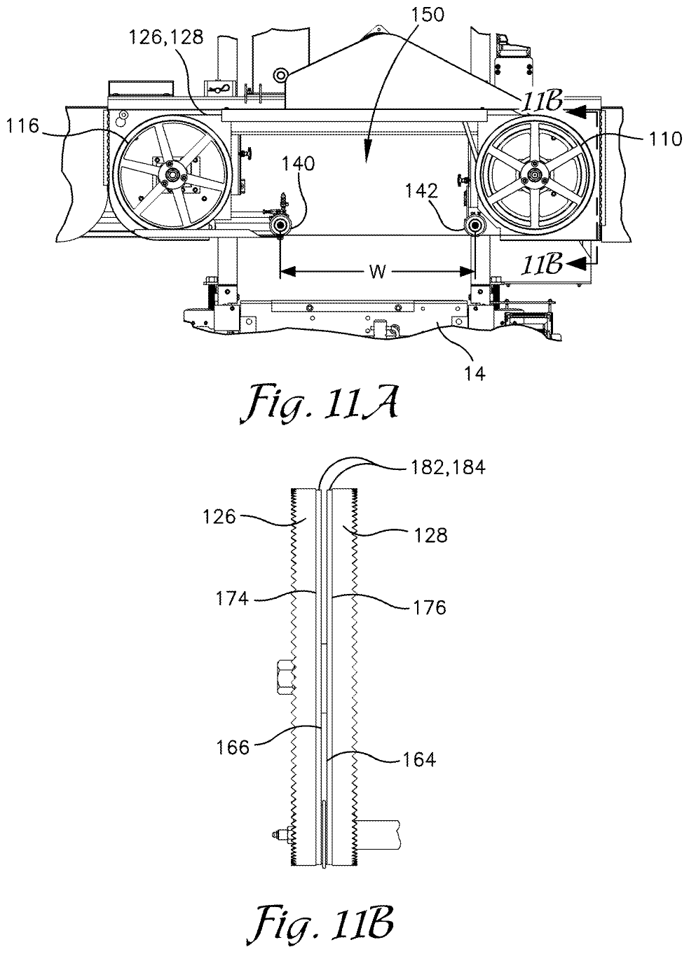

As with the first embodiment, this second embodiment utilizes band saw blades 126, 128 each having back edges 174, 176 and cutting edges 178, 180. The back edges 174, 176 of the band saw blades 126, 128 in this second embodiment, as with the first embodiment, are separated by a narrow gap. When fully assembled, a narrow gap separates the back edges 174, 176 and reduces the potential for snagging of the back edge of the trailing band saw blade on the horizontal surfaces of the log being sawed. Though not essential, an exemplary configuration, as seen in FIG. 11B, may also employ a raised rib 182 on one edge 184 of the blade wheels 160, 162, 164 166 that are adjacent the back edges 174, 176 of the saw blades 126, 128. The height of the raised rib 182 need only be roughly the same, or slightly greater than, the thickness of the saw blades 126, 128 to prevent an undesired displacement of the saw blades from the blade wheels due to the significant forces that are acting upon the blades during the pass through the log.

As with the first embodiment, the second embodiment of the sawmill with bidirectional bandsaw 10 also utilizes guide rollers 190, 192, 194, 196 as seen in FIG. 10, that reside beneath the blades 126, 128 and maintain the orientation of the bandsaw blades 126, 128 during operation. The guide rollers are disposed on opposite sides of the frame 12 and define the outer bounds 144, 146 of the cutting throat 150 of the sawmill 10. The guide rollers of this second embodiment consist of two separate guide rollers per side of the frame 12, for a total of four separate rollers. The guide rollers in their position beneath the blades 126, 128 facilitate a workpiece cut that is parallel to the frame 12.

A variant embodiment utilizes just two guide rollers beneath the blades 126, 128. The advantage of employing just two guide rollers, as opposed to four, is that it reduces the need for roller alignment. The leveling and alignment of two rollers requires less time and effort than the alignment and leveling of four rollers; however, the same high functioning operability can still be achieved with two rollers.

The blade wheels 110, 116 for the first embodiment and for the second embodiment 160, 162, 164, 166 are preferably fabricated from carbon steel and therefore are sufficiently robust and highly durable. The blade wheels, as seen in FIG. 10, are also preferably spoked 200 with an outer circumference 202 in the form of a channel 204. Because a metal saw blade 126, 128 riding atop the circumferential metal surface 202 of the blade wheel would undoubtedly experience slippage when the band saw blade is passing through a workpiece under load, a tightly fitted rubberized V-belt 210 is preferably disposed within and fully circumscribes the channel 204 of each of the blade wheels 126, 128. These rubberized V-belts 210 provide an upper surface 212 that has a far greater surface friction that reduces, and preferably eliminates, slippage of the metal saw blades 126, 128 when the blades are under a heavy cutting load. In addition, the rubberized upper surface 212 of the V-belt 210 facilitates alignment of the blades 126, 128 upon the blade wheels.

In operation, whether in the first or second embodiment as detailed above, an actuating mechanism that is well known in the art is utilized to raise and lower the blade wheels 110, 116 or 160, 162, 164, 166 and saw blades 126, 128 as a unit so that both saw blades are raised above the log and lowered as necessary for engagement with the log. The saw head 16 and the carriage 14 that supports the saw head translate along the frame 12 at a preset height. As detailed above, the rotation of the blade wheels 110, 116 or 160, 162, 164, 166 is powered by the output shaft 94 of the engine 92 after transmission through the electromagnetic clutch 102 to the first clutch pulley 104. Once the electromagnetic clutch 102 is manually activated by the operator, the rotational energy of the clutch pulley 104 is transferred to the drive wheel 106 through the drive belt 100 thereby causing rotation of the blade wheels 110, 116 or 160, 162, 164, 166 and saw blades 126, 128.

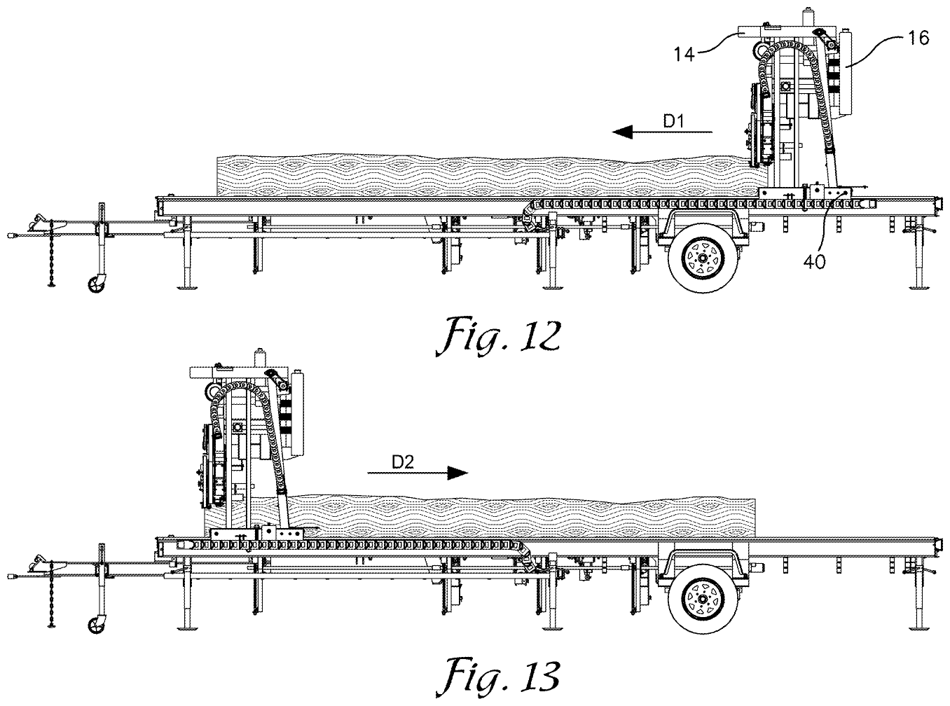

Whether in the first embodiment configuration or the second embodiment configuration as disclosed above, the operator sets the height of the saw head 16 by activating the designated hydraulic or electrical controls thereby causing the carriage 14 and the saw head 16 mounted to the carriage to translate along the frame 12 on the rollers 40 in direction D1. The cutting edge 130 (first embodiment) 178 (second embodiment) of the distally disposed blade 126 advances through the log creating a horizontal cut and the trailing blade 128 following closely behind the advance of the distal blade 126 as seen in FIG. 12.

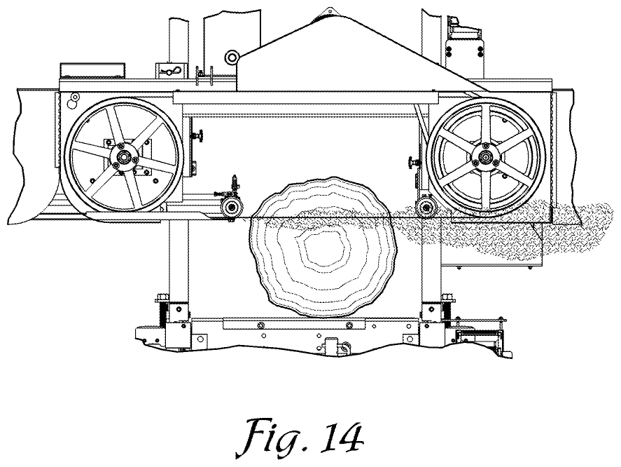

Once the lead and trailing blades 126, 128 exit the log at the opposite end of the horizontal cut, the operator halts the advance of the carriage 12 and saw head 16. The operator then adjusts the elevation of the saw head, typically by lowering the saw head 16. Once the saw head 16 is brought to the desired elevation above the frame 12, the operator advances the cutting edge 132 (first embodiment) 180 (second embodiment) of the oppositely directed band saw 128 back into the log, direction D2, without the need to recycle the carriage 14 and saw head 16 to the starting location as seen in FIG. 13. The existence of an oppositely facing bandsaw blade and its placement proximate the other band saw blade facilitates an increase in the number of board feet of lumber produced per unit of time due to a reduced need to cycle the saw head 16 and thereby increasing productivity. FIG. 14 illustrates a front elevation view of the saw head 16 advancing through a log and discharging sawdust as the lead band saw blade cuts log.

The previously disclosed bidirectional bandsaw sawmill 10 utilizes blade wheels 110, 116 or 160, 162, 164, 166 that are horizontally disposed from one another. This disclosure should not be considered limiting as an alternative embodiment (not shown) may also be configured with blade wheels 110, 116 or 160, 162, 164, 166 that are oriented vertically from one another with the bandsaw blade cutting the workpiece log in a vertical plane. This alternative embodiment requires the guide rollers 140, 142 or 190, 192, 194, 196 be oriented vertically as opposed to horizontally.

The cutting throat in this embodiment would be height limited as the largest dimension of a workpiece that can be cut is limited to the span between the vertically disposed guide rollers. Power transmission to the bandsaw blades 126, 128 in this alternative embodiment would be accomplished in the same fashion with rotational power supplied by the output shaft of an internal combustion engine to an electromagnetic clutch. When activated by the operator, the pulley associated with the electromagnetic clutch would begin to rotate and drive a rubberized belt that partially circumscribes the electromagnetic clutch pulley and the drive pulley that is fastened to the first blade wheel.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Moreover, the order of the components detailed in the system may be modified without limiting the scope of the disclosure.

I claim:

1. A sawmill for cutting logs in successive bi-directional passes, comprising:
a frame with a proximal and distal end, the frame comprising first and second spaced apart horizontally extending beams;
a carriage assembly comprising a first and second pair of spaced apart proximal and distal posts, each pair of posts having an upper end and a lower end wherein spanning between the upper ends of each pair of support posts is an upper connecting member and spanning between the lower ends of each pair of support posts is a lower connecting member, the lower connecting members slidably secured to the first and second horizontally extending beams and a cross-brace extending between the upper ends of the distal posts of the first and second pair of spaced apart posts;
a saw head mounted atop the carriage assembly for mounting thereon a band saw drive source and first and second band saw blade wheels;
first and second band saw blades partially circumscribing the first and second band saw blade wheels with a cutting edge of the first and second band saw blades directed oppositely from one another so that as the carriage assembly and saw head travel along the frame a first horizontal section from the log is cut by the first saw blade and as the carriage assembly and saw head reciprocate on the horizontally extending beams in the opposite direction, a second horizontal section is cut from the log by the second and oppositely directed band saw blade; and
an actuating mechanism for raising and lowering, as a unit, the first and second band saw blades and first and second blade wheels.

2. The sawmill for cutting logs in successive bi-directional passes of claim 1, wherein the first and second band saw blades comprise a cutting edge and a trailing edge.

3. The sawmill for cutting logs in successive bi-directional passes of claim 2, wherein the first and second blade wheels comprise a circumscribing rib for separating the trailing edges of the first and second band saw blades.

4. The sawmill for cutting logs in successive bi-directional passes of claim 3, wherein at least one guide roller is disposed proximate each blade wheel to facilitate leveling and alignment of the rotating bandsaw blade.

5. A sawmill for cutting logs in successive bi-directional passes, comprising:
a frame comprising first and second spaced apart longitudinally extending beams;
a carriage assembly comprising a first and second pair of spaced apart posts, each pair of posts having an upper end and a lower end wherein spanning between the upper ends of each pair of support posts is an upper connecting member and spanning between the lower ends of each pair of support posts is a lower connecting member, the lower connecting members slidably secured to the first and second horizontally extending beams and at least one cross-brace extending between the upper connecting member of the first and second pair of spaced apart posts;
a saw head assembly with a drive side and an unpowered side, the saw head assembly supported by the carriage assembly for mounting a band saw drive source thereon, the drive source operable to transmit rotational power to at least one drive side blade wheel and at least one unpowered side blade wheel to which first and second oppositely directed band saw blades partially envelop the outer circumference of the at least one drive side band saw blade wheel and the at least one unpowered side band saw blade wheel, wherein the carriage assembly and mounted support frame are capable of reciprocating movement along the longitudinally extending beams for making successive back and forth passes across the log; and
an actuating mechanism for raising and lowering the drive side and unpowered side band saw blade wheels and first and second oppositely directed saw blades for positioning in turn each band saw blade for cutting a horizontal section from the log in that respective pass.

6. The sawmill for cutting logs in successive bi-directional passes of claim 5, wherein the band saw blades each comprise a cutting edge and a trailing edge.

7. The sawmill for cutting logs in successive bi-directional passes of claim 6, wherein each of the blade wheels comprise a circumferential channel and a circumferential rib, the trailing edge of each band saw blade disposed adjacent the circumferential rib.

8. The sawmill for cutting logs in successive bi-directional passes of claim 7, wherein the circumferential rib restrains the band saw blade against lateral movement off the band saw blade wheels when cutting a log.

9. The sawmill for cutting logs in successive bi-directional passes of claim 5, wherein at least one guide roller is positioned proximate each of the blade wheels.

10. The sawmill for cutting logs in successive bi-directional passes of claim 5, wherein at least two guide rollers are disposed proximately beneath each band saw blade.

11. The sawmill for cutting logs in successive bi-directional passes of claim 5, wherein the at least one drive side band saw blade wheel is two drive side band saw blade wheels.

12. The sawmill for cutting logs in successive bi-directional passes of claim 5, wherein the carriage assembly includes a plurality of carriage rollers beneath both lower connecting members.

13. The sawmill for cutting logs in successive bi-directional passes of claim 12, wherein the carriage rollers ride atop a rail disposed atop each of the spaced apart longitudinally extending beams of the frame.

14. The sawmill for cutting logs in successive bi-directional passes of claim 7, wherein a tightly fitting rubberized V-belt is positioned within the circumferential channel of each blade wheel.

15. The sawmill for cutting logs in successive bi-directional passes of claim 5, wherein the rotational power of the drive side is provided through a clutch mechanism powered by an engine.

16. The sawmill for cutting logs in successive bi-directional passes of claim 15, wherein a bandsaw drive pulley is positioned between the first and second blade wheels on the drive side of the saw head assembly.

17. The sawmill for cutting logs in successive bi-directional passes of claim 15, wherein a bandsaw drive pulley is positioned proximate to the first blade wheel on the drive side of the saw head assembly.

18. The sawmill for cutting logs in successive bi-directional passes of claim 17, wherein the bandsaw drive pulley is concentrically secured to the first blade wheel with at least one fastener.

19. The sawmill for cutting logs in successive bi-directional passes of claim 5, wherein the bandsaw blades circumscribe approximately 180 degrees of the circumference of the at least one drive side band saw blade wheel and the at least one unpowered side band saw blade wheel.

20. The sawmill for cutting logs in successive bi-directional passes of claim 15, wherein rotational power is transferred to the bandsaw drive pulley by means of a flexible drive belt.
